(19) United States
(12) Patent Application Publication
(10) Pub. No.: US 2015/0160382 A1
(43) Pub. Date: Jun. 11, 2015

(54) OPTICAL ELEMENT AND METHOD FOR PRODUCING THE SAME

(71) Applicant: Seiko Epson Corporation, Tokyo (JP)

(72) Inventors: Akiko YAMADA, Suwa (JP); Kohei YAMADA, Suwa (JP)

(21) Appl. No.: 14/561,568

(22) Filed: Dec. 5, 2014

(30) Foreign Application Priority Data
Dec. 6, 2013 (JP) 2013-252757

(51) Int. Cl. G02B 5/00; G01N 21/552

(52) U.S. Cl. CPC G02B 5/008; G01N 21/554; G01N 2201/06113

(57) ABSTRACT

An optical element is produced by depositing a metal on a substrate in a particulate fashion, and heating the particulate metal in the presence of a compound that contains carbon and silicon.

### BACKGROUND

1. Technical Field

The present invention relates to an optical element and a method for producing the same.

2. Related Art

In recent years, the demands for sensor chips used in applications such as medical diagnosis, and the testing of food and beverage have been increasing, and there is a need for the development of high-sensitive and small sensor chips. Sensor chips based on the electrochemical technique, and various other types of sensor chips have been studied to meet such demands. Sensor chips using surface plasmon resonance (SPR) spectroscopy, particularly surface enhanced Raman scattering have attracted interest because of advantages including integration, low cost, and the applicability to any measurement environment.

Surface plasmons represent an oscillation mode of electron waves coupling to light under surface-inherent interface conditions. One method of exciting surface plasmons is to couple light to plasmons with a diffraction grating fabricated on a metal surface. Another method uses evanescent waves. For example, an SPR sensor is available that is configured to include a total reflection prism, and a metal film formed on a surface of the prism to make contact with a target substance. With this configuration, the sensor detects any adsorption of a target substance, such as the presence or absence of antigen adsorption in antigen-antibody reaction.

In contrast to the surface plasmon that propagates on a metal surface, a localized surface plasmon exists on metallic fine particles. It is known that a localized surface plasmon, specifically a surface plasmon localized on a surface metal microstructure induces a strongly enhanced electric field upon being excited.

It is also known that Raman scattered light is enhanced by surface enhanced Raman scattering when it falls on enhanced electric fields formed by localized surface plasmon resonance (LSPR) using metal particles. A high-sensitive sensor (detector) based on this phenomenon has been proposed. This principle can be exploited to detect trace amounts of various substances.

LSPR sensors are easy to produce, and produce a strong LSPR effect in the visible light region. These sensors thus often use a chip having an island structure of silver or gold fabricated by vapor depositing or sputtering these and other metals on a substrate. JP-A-2013-079442 discloses a chip producing method that includes growing metallic particles on a temperature-adjusted substrate (100 to 450° C.) at an average height growth rate of less than 1 nm/min.

However, a problem of the chips having an island structure is that the large size variation of the metal particles widens the absorbance spectrum, and lowers the absorbance that can be obtained at the target wavelength. The electric fields are thus not always enhanced to the level expected from LSPR (Localized Surface Plasmon Resonance).

### SUMMARY

An advantage of some aspects of the invention is to provide an optical element in which metal particles on a substrate have controlled particle sizes and a reduced particle size variation, and that can desirably enhance an electric field by means of LSPR and a method for producing such an optical element.

The invention can be implemented as the following forms or application examples.

An optical element according to an aspect of the invention is produced by depositing a metal on a substrate in a particulate fashion, and heating the particulate metal in the presence of a compound that contains carbon and silicon.

The metal particles on the substrate have controlled particle sizes and a reduced particle size variation in the optical element. The optical element can thus produce a desirable LSPR electric field enhancement. The optical element can thus be preferably used as an SERS sensor chip.

In the optical element according to the aspect of the invention, the carbon- and silicon-containing compound may have at least one selected from an alkoxy group, a halogen group, and a hydroxyl group.

In this way, the metal particles on the substrate can have a further reduced particle size variation in the optical element, and the optical element can produce an even more desirable LSPR electric field enhancement.

The optical element can thus form a strong LSPR-enhanced electric field under the excitation light of a wavelength in the visible region.

In the optical element according to the aspect of the invention, the particulate metal may be heated to 80° C. to 150° C.

In the optical element according to the aspect of the invention, the metal may be deposited with a deposition device for 100 seconds to 3000 seconds at a deposition rate of 0.1 \acute{Å}/s to 0.5 \acute{Å}/s.

An optical element according to another aspect of the invention includes: a substrate; and metal particles formed after a metal deposited on a surface of the substrate in a particulate fashion is heated in the presence of a compound that contains carbon and silicon, the metal particles having an average particle size of 40 nm to 70 nm, a percentage occupied area of 30% to 60% with respect to the area of the surface of the substrate, and a particle size variation with a coefficient of variation of 0.3 or less.

The metal particles on the substrate have an appropriate average particle size, an appropriate percentage occupied area, and an appropriate particle size variation in the optical element, and the optical element can produce a desirable LSPR electric field enhancement. The optical element can thus be preferably used as an SERS sensor chip.

In the optical element according to the aspect of the invention, the metal particles may have an average particle size of 51 nm to 58 nm, a percentage occupied area of 50% to 55% with respect to the area of the surface of the substrate, and a particle size variation with a coefficient of variation of 0.25 to 0.3.

In the optical element according to the aspect of the invention, the metal may be silver.

An optical element producing method according to still another aspect of the invention includes depositing a metal on a substrate in a particulate fashion; and heating the particulate metal in the presence of a compound that contains carbon and silicon.

The method enables easily producing an optical element in which the metal particles on the substrate have controlled particle sizes and a reduced particle size variation, and that can desirably enhance an electric field by means of LSPR.

### BRIEF DESCRIPTION OF THE DRAWINGS

The invention will be described with reference to the accompanying drawings, wherein like numbers reference like elements.

FIG. 1 is a schematic diagram representing a cross section of a substrate and a metal deposited on the substrate in a particulate fashion.

FIG. 2 is a schematic diagram representing a cross section of a relevant portion of an optical element according to an embodiment.

FIGS. 3A and 3B are schematic diagrams explaining the effect of a coefficient of variation on the wavelength dependence of absorbance.

FIGS. 4A and 4B show the results of the SEM observation of particulate silver and silver particles according to Example of the invention.

FIG. 5 represents absorption spectra of an untreated substrate and a treated substrate according to Example of the invention.

FIGS. 6A and 6B are SERS spectra of untreated substrates and treated substrates for adenine and pyridine according to Example of the invention.

FIGS. 7A to 7C are graphs plotting the SERS intensity for adenine against the average particle size, the percentage occupied area, and the coefficient of variation in the particle size of metal particles according to Example of the invention.

### DESCRIPTION OF EXEMPLARY EMBODIMENTS

Some embodiments of the invention are described below. The following embodiments are intended to solely illustrate the invention. The invention is in no way limited by the following exemplary embodiments, and includes various modifications as may be appropriately made within the gist of the invention. It should also be noted that the configurations described below do not necessarily represent all the essential constituting elements of the invention.

### 1. OPTICAL ELEMENT PRODUCING METHOD

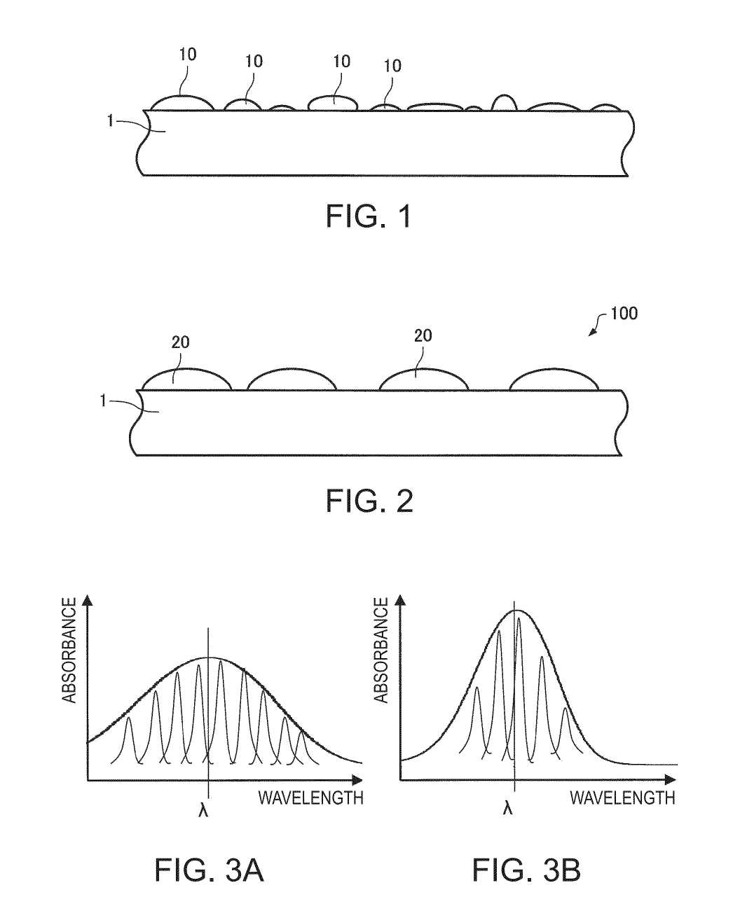

The optical element producing method of the present embodiment includes depositing a metal on a substrate in a particulate fashion, and heating the particulate metal in the presence of a compound that contains carbon and silicon. FIG. 1 is a cross sectional view schematically representing a state after a metal is deposited on a substrate 1 in a particulate fashion. FIG. 2 is a cross sectional view schematically representing a state after metal particles 20 are formed by the heating of a particulate metal 10 in the presence of a compound that contains carbon and silicon.

### 1.1. Depositing Metal on Substrate in Particulate Fashion

The deposition of a metal on the substrate 1 in a particulate fashion is performed with a deposition device, for example, such as a vacuum vapor deposition device, and a sputtering device. The following describes an optical element 100, the substrate 1, the particulate metal 10, and deposition conditions, in this order.

### 1.1.1. Optical Element

The optical element 100 as an example of the optical element produced by the producing method of the present embodiment is described below. As illustrated in FIG. 2, the optical element 100 includes the substrate 1, and the metal particles 20 formed on a surface of the substrate 1.

The optical element 100 including the substrate 1 and the metal particles 20 formed on a surface of the substrate 1 has a structure with an average particle size, a percentage occupied area, and a coefficient of variation of particle size variation (described later) formed by using the producing method of the present embodiment. The optical element 100 is thus applicable to various analysis techniques that take advantage of the electric field enhancement effect by localized surface plasmon resonance (LSPR: Surface Plasmon Resonance) such as SERS.

Specifically, the optical element 100 can generate LSPR near the metal particles 20 upon irradiation of excitation light onto the surface of the substrate 1 with the metal particles 20. The excitation light used to irradiate the optical element 100 is not particularly limited, and is, for example, light of 350 nm to 1000 nm wavelengths, more specifically 532 nm, 633 nm, or 785 nm wavelength. The wavelengths of the light in the excitation light may have a wide or narrow distribution (for example, the excitation light may be of a single wavelength).

Irradiation of excitation light in the presence of the metal particles 20 or the target substance being adsorbed near the metal particle 20 scatters light (Raman scattered light) of a wavelength that differs from the wavelength of the excitation light by the amount of the vibrational energy of the target substance. The scattering is surface enhanced Raman scattering (SERS), enhancing the Raman scattered light 10² to 10¹⁴ fold. A spectrum (fingerprint spectrum) unique to the type of target substance (molecular species) can be obtained in high sensitivity after the spectrometric analysis of the SERS light. Examples of the target substance include biological substances such as bacteria, viruses, proteins, nucleic acids, and various antigens and antibodies, and a variety of compounds ranging from inorganic molecules and organic molecules to macromolecules.

For example, the enhancement of light by the optical element 100 can be used to enhance the Raman scattered light of trace amounts of substances such as inorganic molecules, organic molecules, and macromolecules.

The high enhancement capability of the optical element 100 makes the optical element 100 useful as a sensor capable of quickly and conveniently detecting a target substance in high sensitivity and high accuracy in applications, for example, such as medicine, healthcare, environment, food, and public security.

### 1.1.2. Substrate

The substrate 1 used in the producing method of the present embodiment is not particularly limited. The substrate 1 may be, for example, a glass substrate, a silicon substrate, or a resin substrate. The substrate 1 preferably has an insulating property at least on the surface. The substrate 1 may have a laminate structure with a plurality of layers.

An example of the substrate 1 as a laminate of a plurality of layers is one that includes a metal layer formed on a glass substrate, and a dielectric layer formed on the metal layer. In this case, the surface of the substrate 1 may be a dielectric layer. In this example, the metal layer may be formed of metals, for example, such as silver, gold, aluminum, copper, platinum, and alloys thereof. The dielectric layer may be formed of materials, for example, such as SiO₂, Al₂O₃, TiO₂, polymers, and ITO (Indium Tin Oxide). The metal layer and the dielectric layer in this example may have any thickness, and may be designed taking into consideration propagating plasmon resonance (PSPR), and interference effect. When the substrate 1 is structured as a laminate of a plurality of layers, the optical element 100 may be able to produce an electric field enhancement based on not only localized plasmons but propagating plasmons, and interference effect.

The planar shape of the substrate 1 surface where the particulate metal 10 is provided is not particularly limited. The surface of the substrate 1 to be provided with the particulate metal 10 may have irregularities. However, the surface is preferably flat for obtaining desirable structural changes and a desirable percentage occupied area in the heating step (described later).

The term “flat” as used herein is not intended to mean that the surface is flat (smooth) in the mathematically strict sense that there is absolutely no irregularity. For example, the surface may not be exactly flat in the microscopic view, meaning that the surface may have irregularities attributed to atoms forming the surface, or irregularities attributed to the secondary structures (for example, such as crystals, grains, and grain boundary) of the substance forming the surface. However, macroscopically, such irregularities are so small and unnoticeable that the surface is observable as a flat surface. Thus, in this specification, the surface is said to be flat when it can be regarded as a flat surface in the macroscopic sense.

As used herein, the direction normal to the surface of the substrate 1 on which the particulate metal 10 or the metal particles 20 are formed, or the thickness direction of the substrate 1 will also be called “thickness direction” or “height direction” when describing the particulate metal 10 and the metal particles 20. A planar view of the substrate 1, the particulate metal 10, and the metal particles 20 as used herein means that these are viewed in thickness direction or height direction.

### 1.1.3. Particulate Metal

The particulate metal 10 deposited in the deposition step may have a circular, elliptical, polygonal, or irregular shape, or a combination of these different shapes in planar view. As illustrated in FIG. 1, the particulate metal 10 is formed in the shape of an island on the surface of the substrate 1. Accordingly, the surface of the substrate 1 is exposed between the adjacent islands of the particulate metal 10 in planar view.

The particulate metal 10 may be formed of metals, for example, such as silver, gold, aluminum, copper, and platinum, or alloys of these metals. Preferred as the material of the particulate metal 10 are silver and gold because these metals in the form of the metal particles 20 can generate a localized plasmon resonance (LSPR) when irradiated with light in the visible region.

The particulate metal 10 has an average particle size of 2 nm or more and less than 70 nm in planar view. Average particle size may be determined by using an ordinary method such as image processing, using instruments such as a SEM (Scanning Electron Microscope), and a TEM (Transmission Electron Microscope). The average particle size may be a corresponding diameter of a mean circle obtained by using a method such as image processing. The size (height) of the particulate metal 10 in height direction is not particularly limited, and may be, for example, 1 nm to 60 nm.

The particulate metal 10 becomes the metal particles 20 after the heating of particulate metal in the presence of a compound that contains carbon and silicon, as described in section 1.2. below.

### 1.1.4. Deposition Conditions

The particulate metal 10 is formed on the substrate 1 with a deposition device, for example, such as a vacuum vapor deposition device, and a sputtering device. The deposition device may be a physical vapor deposition device or a chemical vapor deposition device. For example, a device commonly used for the production of semiconductors may be used as the deposition device.

The deposition step is performed by depositing a metal on the substrate 1 with a deposition device. In the deposition step, a metal is deposited in amounts smaller than the amount that forms a metal film on the substrate 1.

A deposition device typically has a characteristic called the deposition rate. The deposition rate (rate of film formation) of the deposition device can be determined, for example, by depositing a metal and forming a metal film on a deposition target, and measuring the time (deposition time) for the deposited metal film to reach a certain thickness. The deposition rate for depositing a metal in amounts smaller than the amount that forms a metal film corresponds to the deposition rate determined as above under the condition that forms a film. The deposition rate may be varied according to different conditions, such as the type of device.

The deposition step is performed to such an extent that the metal 10 forms on the substrate 1 in a particulate fashion. Examples of the deposition conditions of the deposition step include deposition rate, deposition time, substrate temperature, chamber pressure, type of substrate, and type of metal. There are correlations between these conditions set to form the particulate metal 10 on the substrate 1. As an example, the device may have the following conditions.

Deposition rate: 0.01 \acute{Å}/s to 1000 \acute{Å}/s

Deposition time: 0.1 seconds to 3600 seconds

Substrate temperature: −100° C. to 1000° C.

Chamber pressure: 10⁻⁹ Pa to 10⁻³ Pa

When the deposition rate is set to 0.1 \acute{Å}/s to 0.5 \acute{Å}/s, and the deposition time is set to 100 seconds to 3000 seconds, among the conditions described above, the particulate metal 10 with an average particle size of 2 nm or more and less than 70 nm can be formed under a wide range of the other conditions.

The metal 10 can be deposited on the substrate 1 in a particulate fashion in the manner described above.

### 1.2. Heating Particulate Metal in the Presence of Carbon- and Silicon-Containing Compound

The method for producing the optical element 100 of the present embodiment includes heating the particulate metal 10 formed on the substrate 1 in the presence of a compound that contains carbon and silicon as described above.

### 1.2.1. Compound Containing Carbon and Silicon

Examples of the carbon- and silicon-containing compound include organic silane compounds in which the silicon (Si) atom and a carbon (C) atom are directly bonded to each other, and organic silane compounds in which the silicon (Si) atom and a carbon (C) atom are bonded to each other via, for example, an oxygen (O) atom, a sulfur (S) atom, a nitrogen (N) atom, and a phosphorus (P) atom.

The carbon- and silicon-containing compound may have at least one of an alkoxy group, a halogen group, and a hydroxyl group as a group binding to the silicon atom. Other than these groups, the carbon- and silicon-containing compound may have a structure that has had at least one of, for example, an alkyl group, an alkenyl group, an aryl group attached to the silicon atom. These groups may be branched or unbranched, and may be substituted or unsubstituted. The carbon- and silicon-containing compound may contain more than one silicon such as in a siloxane bond, and a silicon-silicon bond.

Specific examples of the carbon- and silicon-containing compound include trimethylmethoxysilane, trimethylethoxysilane, dimethyldimethoxysilane, dimethyldiethoxysilane, diisopropyldimethoxysilane, t-butylmethyldimethoxysilane, t-butylmethyldiethoxysilane, t-amylmethyldiethoxysilane, diphenyldimethoxysilane, phenylmethyldimethoxysilane, diphenyldiethoxysilane, bis-o-tolyldimethoxysilane, bis-m-tolyldimethoxysilane, bis-p-tolyldimethoxysilane, bis-p-tolyldiethoxysilane, bis-ethylphenyldimethoxysilane, dicyclopentyldimethoxysilane, dicyclohexyldimethoxysilane, cyclohexylmethyldimethoxysilane, cyclohexylmethyldiethoxysilane, ethyltrimethoxysilane, ethyltriethoxysilane, vinyltrimethoxysilane, methyltrimethoxysilane, n-propyltriethoxysilane, decyltrimethoxysilane, decyltriethoxysilane, phenyltrimethoxysilane, γ-chloropropyltrimethoxysilane, methyltriethoxysilane, ethyltriethoxysilane, vinyltriethoxysilane, tert-butyltriethoxysilane, thexyltrimethoxysilane, n-butyltriethoxysilane, iso-butyltriethoxysilane, phenyltriethoxysilane, γ-aminopropyltriethoxysilane, chlorotriethoxysilane, ethyltriisopropoxysilane, vinyltributoxysilane, cyclohexyltrimethoxysilane, cyclohexyltriethoxysilane, 2-norbornanetrimethoxysilane, 2-norbornanetriethoxysilane, 2-norbornane methyldimethoxysilane, ethyl silicate, butyl silicate, trimethylphenoxysilane, methyltriallyloxysilane, vinyltris(β-methoxyethoxysilane), vinyltriacetoxysilane, dimethyltetraethoxydisiloxane, hexamethyldisiloxane, hexaethyldisiloxane, hexapropyldisiloxane, hexaphenyldisiloxane, and sodium methyl siliconate.

### 1.2.2. Heating in the Presence of Carbon- and Silicon-Containing Compound

This step is performed with the carbon- and silicon-containing compound being in contact with the particulate metal 10 and the surface of the substrate 1 provided with the particulate metal 10, after the substrate 1 with the particulate metal 10 is disposed in a sealed space. The sealed space is not particularly limited. The sealed space may be a chamber of the deposition device used in the step of forming the particulate metal 10 described above. A sealing container that can provide a sealed space also may be used.

The carbon- and silicon-containing compound can make contact with the particulate metal 10 and the surface of the substrate 1 provided with the particulate metal 10 upon introducing the substrate 1 with the particulate metal 10, and the carbon- and silicon-containing compound into the sealed space (the order of introduction is not limited). Here, the pressure inside the sealed space is not particularly limited, and may be, for example, 10⁻² Pa to 10⁶ Pa. The sealed space pressure may be varied by heating and cooling.

The sealed space may contain substances other than the carbon- and silicon-containing compound. Examples of such other substances include components contained in the atmosphere, such as nitrogen, oxygen, carbon dioxide, and water, inert gases such as argon and helium, and a mixture of these. The moisture inside the sealed space should be removed as much as possible by nitrogen substitution and the like because any water (water vapor) present in the sealed space may react with the carbon- and silicon-containing compound, and cause problems in the heating step.

The amount of the carbon- and silicon-containing compound introduced into the sealed space is appropriately selected according to such factors as the amount of the particulate metal 10, and the area of the substrate 1 on the surface provided with the particulate metal 10. The carbon- and silicon-containing compound may be introduced in amounts in excess of such amounts. This ensures that the carbon- and silicon-containing compound reliably contacts the particulate metal 10, and the surface of the substrate 1.

In the heating step, the particulate metal 10 and the substrate 1 are heated to a temperature of 80° C. to 150° C. with the carbon- and silicon-containing compound being in contact with the particulate metal 10 and the surface of the substrate 1 provided with the particulate metal 10. When the heating temperature (achieving temperature) of the particulate metal 10 and the substrate 1 is less than 80° C., the reaction between the carbon- and silicon-containing compound and the particulate metal 10 or the surface of the substrate 1 with the particulate metal 10 may not proceed sufficiently, and may fail to form the metal particles 20. When the heating temperature (achieving temperature) of the particulate metal 10 and the substrate 1 is above 150° C., the carbon- and silicon-containing compound may decompose, and may fail to form the metal particles 20.

The heating time in the heating step is not limited, as long as a reaction takes place between the carbon- and silicon-containing compound and the particulate metal 10 and/or the surface of the substrate 1 with the particulate metal 10, and the heating time may be longer or shorter than the reaction time. The present inventors have confirmed that a heating time of 1.5 hours to 3 hours is sufficient for obtaining the metal particles 20.

As a specific example of a heating method, the substrate 1 and the particulate metal 10 may be heated to the foregoing temperatures by heating the substrate 1 with a heating mechanism, when a vacuum chamber is used. When using a sealing container, the particulate metal 10 and the substrate 1 may be heated to the foregoing temperatures by introducing and heating the sealing container in a constant-temperature bath adapted to heat the whole sealing container.

In the heating step, a reaction takes place between the carbon- and silicon-containing compound and the particulate metal 10 and/or the surface of the substrate 1, and the particulate metal 10 transforms into the metal particles 20. In the heating step, the carbon- and silicon-containing compound may react with the substrate 1 surface or the particulate metal 10, or with both the substrate 1 surface and the particulate metal 10.

### 1.2.3. Metal Particles

The metal particles 20 that form in the heating step have a particulate shape. The metal particles 20 may have a circular, elliptical, polygonal, or irregular shape, or a combination of these shapes in planar view. The metal particles 20 are formed in the shape of an island on the surface of the substrate 1. Accordingly, the surface of the substrate (the surface after the reaction) is exposed between the adjacent islands of the metal particles 20 in planar view.

The metal particles 20 may form from a material that contains the reaction product of the carbon- and silicon-containing compound and the metal used for the particulate metal 10. In this case, the metal particles 20 may be structured from the metal used for the particulate metal (nucleus), and the reaction product (shell). When the material of the particulate metal 10 is silver or gold, the metal particles 20 can produce LSPR upon being irradiated with light in the visible region.

The metal particles 20 formed after the reaction in the heating step have a larger average particle size than the particulate metal 10 before the reaction, and have a smaller particle size variation.

### 1.2.4. Metal Particle Structure

The metal particles 20 after the heating step have an average particle size (average particle diameter) of 40 nm to 70 nm, preferably 45 nm to 65 nm, more preferably 50 nm to 60 nm, particularly preferably 51 nm to 58 nm as measured in planar view. The metal particles 20 after the heating step have a larger average particle size than the particulate metal 10 before heated in the heating step. The size (height) of the metal particles 20 in height direction is not particularly limited, and may be, for example, 1 nm to 70 nm.

The metal particles 20 on the substrate 1 after the heating step has a percentage occupied area of 30% to 60%. As used herein, “percentage occupied area” is the proportion of the area in planar view of the metal particles 20 occupying the area of the substrate 1 where the metal particles 20 are formed. The percentage occupied area of the metal particles 20 after the heating step is smaller than the percentage occupied area of the particulate metal 10 on the substrate 1 before the heating. Specifically, the particulate metal 10 undergoes changes in position, shape, or structure on the substrate 1 as it transforms into the metal particles 20 in the heating step, and increases the exposed area on the surface of the substrate 1 (or the surface of the substrate 1 after the reaction).

The reduced percentage occupied area of the metal particles 20 after the heating step increases the particle intervals, and makes it easier for the target substance to enter the space between the particles. The space between the metal particles 20 involves high LSPR intensity, and represents a so-called “hot spot” where there is a high electric field enhancement. The target substance can thus more easily approach the hot spot after the heating step, and, for example, the Raman scattered light of the target substance is more strongly enhanced. The strong electric field enhancement effect by LSPR due to interaction between particles may not be obtained when the percentage occupied area is excessively small and widens the intervals between the metal particles 20. From this standpoint, the percentage occupied area of the metal particles 20 is more preferably 30% to 60%, further preferably 50% to 55%.

After the heating step, the metal particles 20 on the substrate 1 have a particle size variation with a coefficient of variation of 0.3 or less (30% or less). Coefficient of variation (CV) is represented by the following formula (1).

$$CV = \frac{σ}{\overline{𝒳}} \\ ( σ \text{:} Standard deviation of particle size , \\ \overline{𝒳} \text{:} Arithmetic average of particle size ) \qquad ( 1 )$$

The arithmetic average of particle size, and the standard deviation of particle size (distribution) are given by the following formulae (2) and (3), respectively.

$$\begin{matrix}\overline{𝒳} = \frac{{\sum }_{i = 1}^{n} {𝒳}_{i}}{n} & ( 2 ) \\ σ = \sqrt{\frac{{\sum }_{i = 1}^{n} ( {𝒳}_{i} - \overline{𝒳} )}{n}} & ( 3 )\end{matrix}$$

In the formulae, χᵢ represents the particle size of the i^{th} particle, and n represents the number of particles. The particle size (diameter) of the metal particles 20 can be determined by using an ordinary method such as image processing, using an instrument such as SEM and TEM. The particle size may be a corresponding size (corresponding diameter) of a circle obtained by using a method such as image processing. In the calculations of these values, n is preferably 30 or more, more preferably 50 or more, further preferably 100 or more.

FIGS. 3A and 3B are schematic diagrams explaining the effect of a coefficient of variation on the wavelength dependence of absorbance. As represented in FIG. 3A, the absorption spectra (thinner lines in the figure) by the individual metal particles 20 distribute over a wide wavelength range when the coefficient of variation, or the particle size variation is large. In contrast, as represented in FIG. 3B, the absorption spectra (thinner lines in the figure) by the individual metal particles 20 distribute over a narrower wavelength range when the coefficient of variation, or the particle size variation is small.

Accordingly, the absorption spectrum (thicker line in the figure) by the whole metal particles 20 on the substrate 1 is sharper (smaller half width), and the maximum value of absorbance is greater with a smaller coefficient of variation (FIG. 3B) than with a larger coefficient of variation (FIG. 3A). Apparently, the electric field enhancement by LSPR becomes stronger as the corresponding absorbance of the excitation wavelength increases. It is therefore possible to obtain a stronger LSPR enhanced electric field by appropriately selecting the excitation wavelength and the average particle size when the coefficient of variation is small. In other words, the heating step makes the particle sizes of the metal particles 20 more uniform, and reduces the particle size variation to improve the electric field enhancement by LSPR at specific wavelengths.

It should be noted that the enhancement by LSPR at a given wavelength increases as the coefficient of variation becomes smaller. However, the LSPR absorbance tends to deviate from the wavelength of the excitation light or Raman scattered light when the variation is too small. It may thus be preferable to have some variation. The coefficient of variation of the particle size of the metal particles 20 on the substrate 1 is more preferably 0.15 to 0.3 (15% to 30%), further preferably 0.25 to 0.3 (25% to 30%).

### 1.3. Advantages

The optical element producing method of the present embodiment includes depositing the metal 10 on the substrate 1 in a particulate fashion, and heating the particulate metal 10 in the presence of a compound that contains carbon and silicon. This makes it possible to easily produce the optical element 100 in which the metal particles 20 on the substrate 1 have controlled particle sizes and a reduced particle size variation.

In the optical element 100 produced by the producing method of the present embodiment, the metal particles 20 formed on the substrate 1 have an average particle size of 40 nm to 70 nm, a percentage occupied area of 30% to 60%, and a particle size variation with a coefficient of variation of 0.3 or less. In this way, the optical element 100 can develop a high LSPR electric field enhancement. The optical element 100 can thus be used as a sensor that can enhance the Raman scattered light of trace amounts of various target substances for quick and easy detection of a target substance in high sensitivity and high accuracy.

### 2. EXAMPLES

The invention is described below in greater detail using some Examples. The invention, however, is in no way limited by the following Examples.

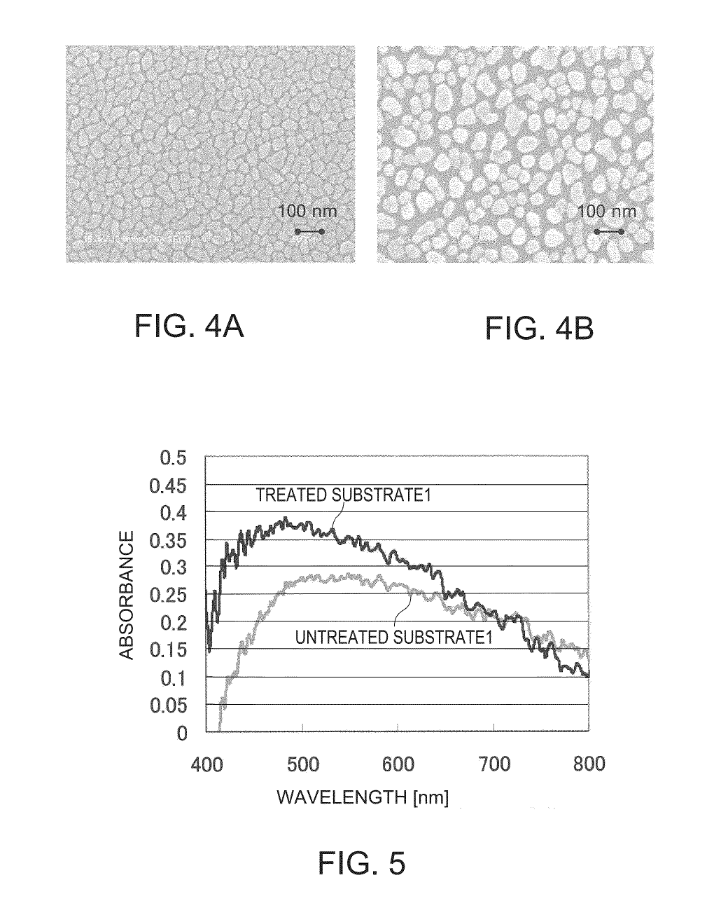

FIG. 4A shows a result of the SEM observation of a glass substrate that has had silver deposited in a particulate fashion, and FIG. 4B shows a result of the SEM observation of the glass substrate after heating the particulate silver at 100° C. for 3 hours in the presence of decyltrimethoxysilane.

The particulate silver was formed by vapor depositing silver on a glass substrate (thickness 0.2 mm, size 10 mm×10 mm) for 500 seconds at a deposition rate of 0.2 \acute{Å}/s (translates into a 10-nm thickness if the silver were formed in the form of a film rather than particles). An UHV vapor deposition device (Biemtron) was used for the vapor deposition. The substrate temperature was 25° C., and the chamber pressure was 4.0×10⁻⁵ Pa.

The SEM observation of the silver-deposited surface of the glass substrate revealed that the silver formed on the glass substrate was in the form of islands, measuring about several ten nanometers in particle size (diameter) in planar view, as shown in FIG. 4A (the substrate in this state will be referred to as “untreated substrate 1”). As demonstrated above, the metal disposed in the form of islands can be obtained after the deposition step in which the metal was deposited on the substrate in a particulate fashion at a deposition rate of about 0.1 \acute{Å}/s to 0.5 \acute{Å}/s, and a deposition time of about 100 seconds to 3000 seconds.

The silver-deposited glass substrate (untreated substrate 1; FIG. 4A) was irradiated with a laser beam of a wavelength (633 nm) in the visible region from the side of the silver-deposited surface. A strong electric field enhancement by the excited localized surface plasmon resonance (LSPR) was confirmed between the silver particles.

The glass substrate with the deposited particulate silver (untreated substrate) obtained in the manner described above was placed in a nitrogen atmosphere inside a sealing container (0.2 L volume), and the container was sealed after adding 20 μL of decyltrimethoxysilane. The sealing container was then introduced into a 100° C. constant-temperature bath, and heated for 3 hours.

The surface of the glass substrate with the silver particles (metal particles) was observed by SEM. The result is shown in FIG. 4B. The particle sizes of the silver particles (metal particles) slightly increased, and the particle size variation became smaller after the heat treatment with the decyltrimethoxysilane, as compared to the original particulate silver shown in FIG. 4A (the substrate after the heat treatment will be referred to as “treated substrate 1”). The particle size (diameter) of each particle was determined from the SEM images shown in FIGS. 4A and 4B, and calculations were performed to find the average particle size, the standard deviation, and the coefficient of variation according to the formulae (1) to (3) above. A total of 100 particles were measured in each measurement (n=100). The percentage occupied area was determined by defining squares each measuring 1 μm each side.

An untreated substrate 2 and a treated substrate 2 were fabricated by using the same procedures used for the untreated substrate 1 and the treated substrate 1.

Table 1 presents the average particle size, percentage occupied area, and coefficient of variation values of the untreated substrates 1 and 2, and the treated substrates 1 and 2.

TABLE 1

| | | | | SERS | SERS |
|---|---|---|---|---|---|
| | | | | peak in- | peak in- |
| | Average | Percentage | Coefficient | tensity for | tensity for |
| | particle | occupied | of variation | adenine | pyridine |
| Sample | size (nm) | area (%) | (—) | (count) | (count) |
| Untreated | 39.9 | 74.4 | 35.9 | 480 | 1060 |
| substrate 1 | | | | | |
| Treated | 57.1 | 54.2 | 29.9 | 1950 | 20280 |
| substrate 1 | | | | | |
| Untreated | 30.8 | 64.2 | 56.7 | 530 | — |
| substrate 2 | | | | | |
| Treated | 51.6 | 54.3 | 25.1 | 2200 | — |
| substrate 2 | | | | | |

As can be seen in Table 1, the average particle size of the silver particles was 57.1 nm in the treated substrate 1 subjected to the heat treatment with decyltrimethoxysilane, an increase from 39.9 nm in the untreated substrate 1. The coefficient of variation, representing the extent of particle size variation, was 29.9% in the treated substrate 1, a decrease from 35.9% in the untreated substrate 1. The more uniform particle size, and the reduced particle size variation in the treated substrate 1 should improve the LSPR electric field enhancement at specific wavelengths.

Similarly, the average particle size of the silver particles was 51.6 nm in the treated substrate 2 subjected to the heat treatment with decyltrimethoxysilane, an increase from 30.8 nm in the untreated substrate 2. The coefficient of variation, representing the extent of particle size variation, was 25.1% in the treated substrate 2, a decrease from 56.7% in the untreated substrate 2. The more uniform particle size, and the reduced particle size variation in the treated substrate 2 should improve the LSPR electric field enhancement at specific wavelengths.

The percentage occupied area of the silver (particulate silver, and silver particles) with respect to the substrate area was 74.4% and 64.2% for the untreated substrates 1 and 2, respectively, and 54.2% and 54.3% for the treated substrates 1 and 2, respectively. This appears to be the result of the slightly increased intervals between the particles (metal particles), allowing the substrate to undergo change in the structure in which substances easily enter the site (hot site) where there is a strong electric field enhancement.

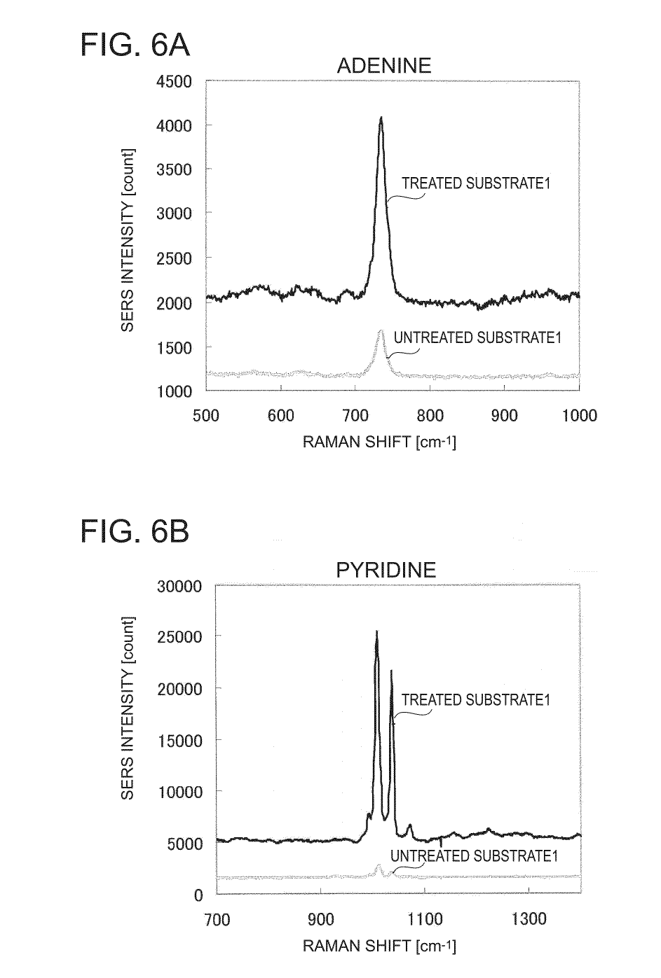

FIG. 5 represents absorption spectra of the untreated substrate 1 and the treated substrate 1 (under a white light source). It would appear that a higher absorbance indicates a stronger electric field enhancement by LSPR to be exited at the corresponding wavelength. The treated substrate 1 has higher absorbances than the untreated substrate 1 over the 400 nm to 700 nm region, and the LSPR electric field enhancement should be high at these wavelengths.

The treated substrate 1 was subjected to SERS to examine whether there was any improvement in the enhancement by LSPR. Adenine and pyridine were used as target molecules. An adenine measurement sample was prepared by dropping a 7.4×10⁻⁷ mol/L adenine aqueous solution onto a substrate, and drying the substrate. For pyridine measurement, the substrate was subjected to SERS by exposing the substrate to a saturated vapor of pyridine. For the measurement condition, a laser beam of 632.8 nm wavelength was used at an intensity of 2 mW for 10 seconds in the adenine measurement, and at an intensity 0.5 mW for 30 seconds for the pyridine measurement.

The pyridine measurement was performed for the untreated substrate 1 and the treated substrate 1. The adenine measurement was performed for the untreated substrates 1 and 2, and the treated substrates 1 and 2. FIG. 6A represents the SERS spectra of the untreated substrate 1 and the treated substrate 1 for adenine. FIG. 6B represents the SERS spectra of the untreated substrate 1 and the treated substrate 1 for pyridine. The SERS intensity observed in each substrate is presented in Table 1.

The treated substrate had greatly improved SERS intensities for both adenine and pyridine compared to the untreated substrate. The improvement was as high as about 4 times for adenine, increasing from 480 counts and 530 counts in the untreated substrates 1 and 2 to 1950 counts and 2200 counts in the treated substrates 1 and 2. For pyridine, the SERS intensity improved about 20 times from 1060 counts in the untreated substrate 1 to 20280 counts in the treated substrate 1.

This appears to the result of the heat treatment performed in the presence of decyltrimethoxysilane (carbon- and silicon-containing compound), causing structural changes in the island structure of the silver particles, and increasing the particle size and reducing the particle size variation, and improving the LSPR electric field intensity under the excitation light of 633 nm wavelength.

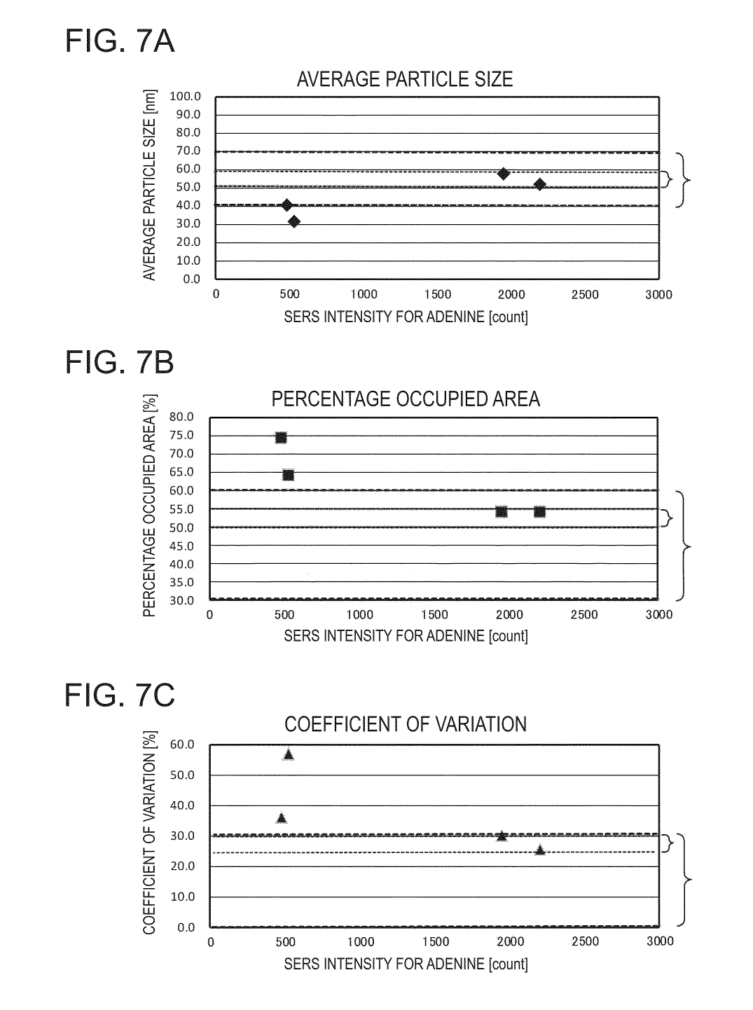

FIG. 7A to FIG. 7C are graphs relating to the SERS measurement for adenine, plotting the adenine SERS intensity against the average particle size (FIG. 7A), the percentage occupied area (FIG. 7B), and the coefficient of variation (FIG. 7C) of the particulate silver or silver particles. As can be seen from FIG. 7A, the SERS intensity abruptly increased when the average particle size of the silver particles was 40 nm or more. It was also confirmed that the SERS intensity was high when the average particle size of the silver particles was 51 nm to 58 nm. As can be seen from FIG. 7B, it was found that the SERS intensity abruptly increased when the percentage occupied area of the silver particles was 60% or less. It was also confirmed that the SERS intensity was high when the percentage occupied area of the silver particles was 50% to 55%. As can be seen from FIG. 7C, it was found that the SERS intensity abruptly increased when the coefficient of variation of the particle size of the silver particles was 0.3 (30%) or less. It was also confirmed that the SERS intensity was high when the coefficient of variation of the silver particles was 0.25 (25%) to 0.3 (30%).

The invention is not limited to the foregoing exemplary embodiment, and may be modified in many ways. For example, the invention encompasses configurations substantially the same as the configurations described in the embodiment (for example, configurations sharing the same functions, methods, and results, or configurations sharing the same objects and effects). The invention also encompasses configurations in which non-substantive parts of the configurations of the foregoing embodiment are substituted. The invention also encompasses configurations having the same advantages as the configurations of the foregoing embodiment, or configurations that can achieve the same object as the configurations of the foregoing embodiment. The invention also encompasses configurations that use known techniques with the configurations described in the foregoing embodiment.

The entire disclosure of Japanese Patent Application No. 2013-252757, filed Dec. 6, 2013 is expressly incorporated by reference herein.

What is claimed is:

1. An optical element produced by depositing a metal on a substrate in a particulate fashion, and heating the particulate metal in the presence of a compound that contains carbon and silicon.

2. The optical element of claim 1,
wherein the carbon- and silicon-containing compound has at least one selected from an alkoxy group, a halogen group, and a hydroxyl group.

3. The optical element of claim 1,
wherein the particulate metal is heated to 80° C. to 150° C.

4. The optical element of claim 1,
wherein the metal is deposited with a deposition device for 100 seconds to 3000 seconds at a deposition rate of 0.1 \acute{Å}/s to 0.5 \acute{Å}/s.

5. An optical element comprising:
a substrate; and
metal particles formed after a metal deposited on a surface of the substrate in a particulate fashion is heated in the presence of a compound that contains carbon and silicon,
the metal particles having an average particle size of 40 nm to 70 nm, a percentage occupied area of 30% to 60% with respect to the area of the surface of the substrate, and a particle size variation with a coefficient of variation of 0.3 or less.

6. The optical element of claim 5, wherein the metal particles have an average particle size of 51 nm to 58 nm, a percentage occupied area of 50% to 55% with respect to the area of the surface of the substrate, and a particle size variation with a coefficient of variation of 0.25 to 0.3.

7. The optical element of claim 1, wherein the metal is silver.

8. An optical element producing method comprising:
depositing a metal on a substrate in a particulate fashion; and
heating the particulate metal in the presence of a compound that contains carbon and silicon.
